(19) United States
(12) Patent Application Publication
(10) Pub. No.: US 2010/0034191 A1
(43) Pub. Date: Feb. 11, 2010

(54) METHOD AND SYSTEM FOR TIME SYNCHRONIZATION IN A SENSOR NETWORK

(75) Inventor: Gerrit Schulz, Stuttgart (DE)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N. V., Eindhoven (NL)

(21) Appl. No.: 12/445,361

(22) PCT Filed: Oct. 8, 2007
(86) PCT No.: PCT/IB07/54086

§ 371 Date: Apr. 13, 2009

(30) Foreign Application Priority Data
Oct. 12, 2006 (EP) 06122156.0

(51) Int. Cl. H04J 3/06

(52) U.S. Cl. 370/350

(57) ABSTRACT

In a network node synchronization method and system a first timestamp (TSA) is captured at a first network node system (A) just prior to transmitting a data packet (DP) to a second network node system (B) and incorporated in said data packet (DP). Upon receiving a control block of data (SFD) comprised in the data packet (DP), the second network node system (B) captures a second timestamp (TSB). The delay between capturing the first timestamp (TSA) and the second timestamp (TSB) comprises a number of deterministic delays and a propagation time (PT). Eliminating the deterministic delays, only a small synchronization error due to the propagation time (PT) remains. As the propagation time (PT) may be very small, the synchronization may be very accurate. Further, as the synchronization may be performed using any data packet (DP), the present invention may be employed in any kind of network system and network protocol. Further, a method according to the present invention uses very little overhead, thereby being very suitable for low energy applications, e.g. in a wireless sensor network.

### FIELD OF THE INVENTION

The present invention relates to a method for time synchronization in a computer network, in particular in a sensor network and to a system for use in the method. More in particular, the present invention relates to time synchronization in wireless sensor networks.

### BACKGROUND OF THE INVENTION

In computer networks and in particular in sensor networks, network node systems may exchange data that relate to a point in time. For example, multiple measurements of a phenomenon may be sensed by a number of sensors and corresponding signals may be transferred to a single network node system, such as a suitable computer system. In order to correlate the signals, the physical time at which the signals are generated may be important. For example, a medical system may monitor a heartbeat and a blood pressure of a patient using two separate sensors and gathering the resulting heart beat measurement signal and the resulting blood pressure signal at a computer system. When examining the two resulting signals, the heartbeat signal and the blood pressure signal are interrelated and should be examined in relation to each other. If the sensors are not synchronized, the two resulting signals may appear time-shifted with respect to each other.

Further, time synchronization may be used for network management tasks. For example, in a Time Division Multiple Access (TDMA) network, a synchronized wake-up of each of the network nodes may increase the network management efficiency and thereby reduce power consumption of the network nodes.

In the prior art, a number of synchronization methods and protocols are known, such as the Network Time Protocol (NTP). However, common computer-network synchronization methods may not be suitable for a sensor network. In the prior art, a number of sensor network synchronization protocols are known such as the Reference-Broadcast Synchronization (RBS), the Timing-Sync Protocol for Sensor Networks (TPSN), the Flooding Time-Synchronization Protocol (FTSP) and the like. Different methods or protocols may be specifically suitable for certain applications. For example, some may be more suitable for high precision synchronizing, others may be suitable for energy-efficient applications, i.e. for sensors having a limited power resource. The latter is in particular relevant to wireless sensor networks. For more details on sensor network time synchronization reference is made to Kay Römer, et al., “Time Synchronization and Calibration in Wireless Sensor Networks”, in: Ivan Stojmenovic (Ed.), Handbook of Sensor Networks: Algorithms and Architectures, John Wiley & Sons, ISBN 0-471-68472-4, pp. 199-237, September 2005.

### OBJECT OF THE INVENTION

It is an object of the present invention to provide a method and system for time synchronization in a wireless sensor network having a high accuracy and being power efficient.

### SUMMARY OF THE INVENTION

The object is achieved in a method according to claims 1 and 8, and a system according to claims 9 and 10.

In accordance with the present invention data is prepared for transmission over the network by generating a data packet comprising a control block, such as a header, and a data block comprising said data. The data packet is provided to a transceiver. Then, a network access control element waits for network media access during a network access period, such as a back-off period. The duration of the network access period may vary depending a the network protocol used and the network load. When the network access period is at the end, a first node timestamp is captured from the first network node system and incorporated in the data packet. Then, the data packet is transmitted. Thus, the timestamp represents the time of transmission as close as possible, eliminating an inaccuracy resulting from the network access period. It is noted that the above-described method steps are usually performed in a so-called MAC-layer. The MAC-layer is a part of network-management software. In particular, the MAC layer is one of two sublayers that make up a Data Link Layer of the OSI model, which is known by those skilled in the art. The MAC-layer is responsible for moving data packets to and from a network interface card of a first network node to another network interface card of a another network node across a shared channel through a medium.

In the method according to the present invention, a high accuracy is obtained by timestamping after the network access period and energy efficiency is obtained by minimizing communication overhead by enabling time synchronization with each and every data packet to be sent. The method according to the present invention may be employed in various network systems and structures as no assumptions on the structure, topology and protocols are made. Dedicated synchronization messages may be sent, but are not required in the method. The method may be employed in Broadcast and in Unicast networks, as is apparent to those skilled in the art.

The second network node system receiving the data packet may capture a second node timestamp upon receiving a predetermined part of a data packet, the data packet being transmitted in accordance with the above-described method. Thereafter, the second node system may compare the first node timestamp and the second node timestamp and determine a time difference between the first network node system and the second network node system, taking into account any deterministic delay that may have occurred in the transmission. As the first node timestamp has been captured such that the delay between the capturing and the actual transmission is deterministic, the delay occurring at the first network node system may be eliminated. Consequently, only an unknown propagation delay remains as is explained below in relation to the drawings.

### BRIEF DESCRIPTION OF THE DRAWINGS

Hereinafter, the present invention is elucidated with reference to non-limiting embodiments as illustrated in the appended drawings, in which

FIG. 1 shows a timing diagram for illustrating a network communication delay between sending and receipt of a data packet;

FIG. 2 shows a diagram for illustrating an embodiment of a method according to the present invention;

FIG. 3 shows a timing diagram illustrating measurement results of a synchronization error in a method according to the present invention; and

FIG. 4 schematically illustrates an embodiment of a system according to the present invention.

### DETAILED DESCRIPTION OF EXAMPLES

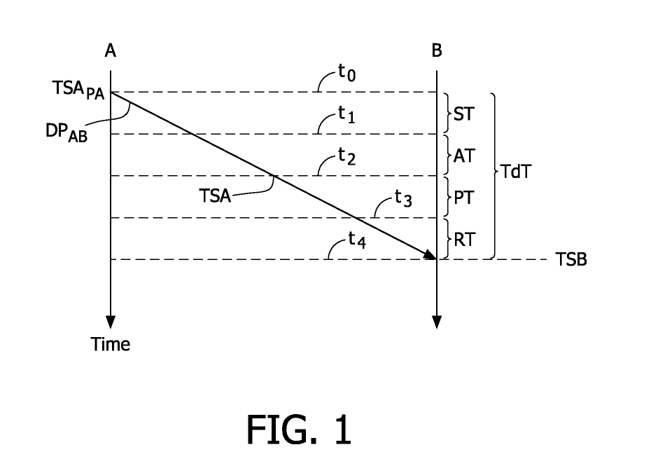

FIG. 1 illustrates a model of a total delay time TdT which delay time occurs when sending a data packet DP_{AB} from a first network node system A to a second network node system B (horizontally separated). On a vertical axis, time is represented.

At t₀, the data packet DP_{AB} is prepared for transmission. The data packet DP_{AB} is to be constructed at the first network node system A. The construction may comprise kernel protocol processing and other variable delays introduced by an operating system of the first network node system A. Further time is required for transferring the data packet DP_{AB} to a network interface of the first network node system A. The time required for construction and transfer to the network interface is commonly and hereinafter referred to as a send time ST (t₀-t₁).

At t₁, the data packet DP_{AB} is prepared and waiting at the network interface to be transmitted by means of wires or wireless. Before being transmitted, a network medium channel needs to be available, i.e. not being in use. Depending on the network protocol used, in particular the Media Access Control (MAC) protocol used, an access time AT (t₁-t₂) has to be waited before the data packet DP_{AB} may be transmitted over the network medium. For example, contention-based MACs (e.g. Ethernet) must wait for the channel to be clear before transmitting, and retransmit in the case of a collision. Wireless RTS/CTS schemes such as those in IEEE 802.11 networks require an exchange of control packets before data can be transmitted. TDMA channels require a sender to wait for its slot before transmitting.

Once transmitted, at t₂, the data packet DP_{AB} propagates through the network medium inducing a propagation time PT (t₂-t₃). When the sending first network node system A and receiving second network node system B share access to a same physical media (e.g., neighbors in an ad-hoc wireless network, or on a wired LAN), the propagation time PT may be very small as it is simply the physical propagation time of the data packet. In contrast, in wide-area networks, the propagation time PT includes the queuing and switching delay at each router as the data packet DP_{AB} transits through the network.

Then, at t₃, the data packet DP_{AB} is received at the second network node system B taking a receive time RT (t₃-t₄) for processing of the network interface. Thus, the data packet DP_{AB} is received at the second network node system B after a total delay time TdT, which total delay time TdT is composed of the send time ST, the access time AT, the propagation time PT and the receive time RT.

Each of the above-mentioned delay times ST, AT, PT, RT have a variable length and may not be calculated prior to sending or after receiving the data packet DP_{AB}. Consequently, if in accordance with a prior art protocol, a prior art timestamp TSA_{PA} is captured at the first network node system A at to, the prior art timestamp TSA_{PA} is received at the second network node system B at t₄. If the prior art timestamp TSA_{PA} is used for synchronizing clocks of the two network node systems A, B, a synchronization error corresponding to the total delay time TdT results.

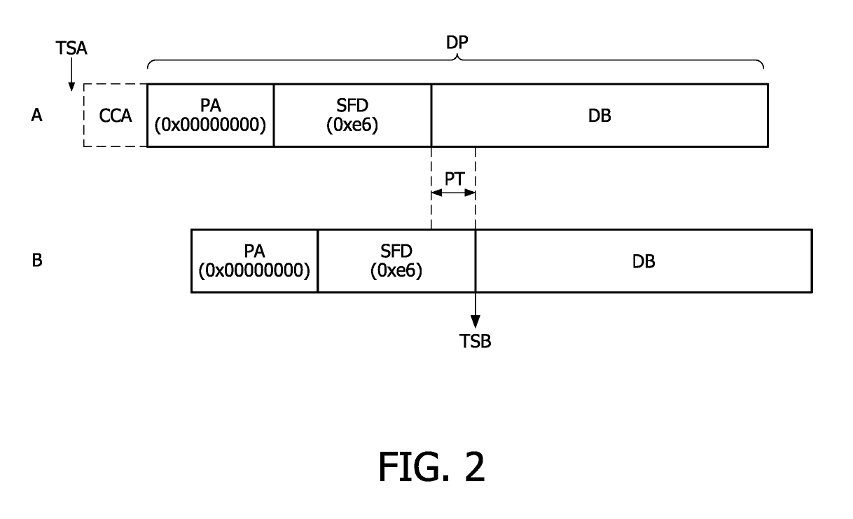

In a method in accordance with the present invention, a timestamp TSA is not captured at t₀, but at t₂ just prior to actual transmission, thereby eliminating the unknown send time ST and the unknown access time AT. Below, the present invention is further elucidated with reference to FIG. 2.

FIG. 2 shows a diagram, illustrating an embodiment of the method according to the present invention. Vertically, a first diagram relating to a first network node system A and a second diagram relating to a second network node system B are separated. The first and the second diagram are horizontally shifted with respect to each other corresponding to a propagation time PT, as is explained hereinafter.

The first network node system A is sending data to the second network node system B and simultaneously the clocks of the first network node system A and the second network node system B are to be synchronized. The data is comprised in a data packet DP comprising a preamble PA, a start-of-frame delimiter SFD and a data block DB. The preamble PA and the start-of-frame delimiter SFD are considered a control block comprising network control data (overhead data). Such a data packet DP is in accordance with the prior art. In particular, the start-of-frame delimiter SFD indicates that the data block starts and has a same value for each data packet.

Just prior to performing a clear channel assessment CCA, the first network node system A captures a first timestamp TSA and incorporates the first timestamp TSA in the data packet DP. The clear channel assessment CCA is performed at the end of the access time (FIG. 1: AT). Then, presuming that the network medium channel is available, the data packet DP including the first timestamp TSA is transmitted. After the propagation time PT, the data packet DP is received at the second network node system B, which is illustrated in FIG. 2 by the horizontal shift of the second diagram relating to the second network node system B with respect to the first diagram relating to the first network node system A.

The start-of-frame delimiter SFD has a known value. Upon detecting the receipt the start-of-frame delimiter SFD, the second network node system B captures a second timestamp TSB from its timer or clock. The received first timestamp TSA and the second timestamp TSB may then be compared in order to synchronize the timer or clock of the second network node system B with the timer or clock of the first network node system A.

As is apparent from FIG. 2, the second timestamp TSB is taken later than the first timestamp TSA. A total delay is comprised of a time required for the clear channel assessment CCA, a time required for transmitting the preamble PA and the start-of-frame delimiter SFD and the propagation time PT. However, the time required for the clear channel assessment CCA, the transmission of the preamble PA and the transmission of the start-of-frame delimiter SFD can be determined. For example, in a IEEE 802.15.4 (Zigbee) network, a symbol time for the 2.4 GHz band is 16 μs. Four bits are coded in one symbol. Hence, transmission of one byte (eight bits) therefore requires two symbols and consequently 32 μs. A turnaround time for the radio (clear channel assessment CCA) is specified with twelve symbol periods (192 μs). So, apart from the propagation time PT, the delay is 352 μs. It is noted that the use of the start-of-frame delimiter SFD as well substantially eliminates, or at least reduces a time delay that may result from receiving the data packet DP (FIG. 1: receive time RT).

As is apparent to those skilled in the art, the use of the start-of-frame delimiter SFD allows the present invention to be implemented in any network system and network protocol without substantially changing the network protocol. However, any other predetermined control block of data may as well be used, all time delays prior to receiving the predetermined control block of data preferably being deterministic.

The propagation time PT may be relatively small compared to the above-mentioned delays. In particular in a network in which a sending network node system and a receiving network node system are connected to the same network medium as may be true for wireless networks, for example. In such a network the propagation time is the physical propagation time trough the medium.

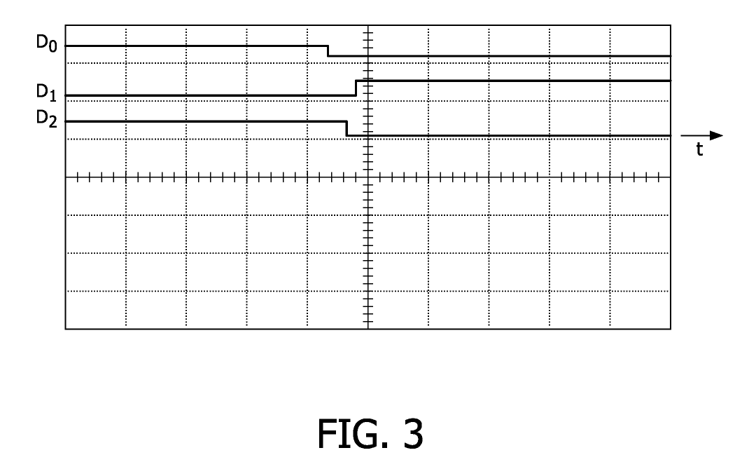

FIG. 3 shows experimental results. The horizontal axis of the diagram shown in FIG. 3 represents time t. The time scale is 5 μs/div. Three signals D₀, D₁, D₂ from three network nodes are shown. The three signals D₀, D₁, D₂ are expected to have a level change at substantially the same time. As is apparent from FIG. 3, a synchronization error between the three network nodes is significantly less than 5 μs.

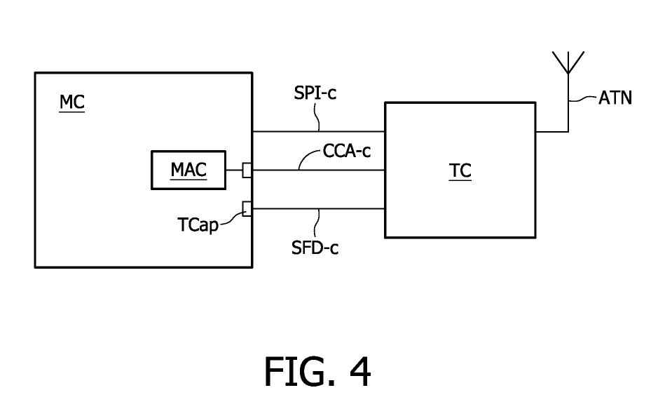

FIG. 4 shows an embodiment of a network node system comprising a microcontroller MC and a transceiver TC. The microcontroller MC and the transceiver TC are operatively connected by a data connection SPI-c for data transfer. The data may be data to be transmitted by the transceiver TC or may be data received by the transceiver TC. A second connection CCA-c is a control connection for enabling the microcontroller MC to perform clear channel assessment (CCA) using the transceiver TC. Thereto, the second connection CCA-c is coupled to a network medium access control element (MAC). A third connection SFD-c is a control connection for supplying a timer control signal from the transceiver TC to the microcontroller MC upon having received the start-of-frame delimiter (SFD). The third connection SFD-c is connected to a timer capture input terminal Tcap of the microcontroller MC such that upon receiving the timer control signal from the transceiver TC, the microcontroller MC captures a timestamp in accordance with the method of the present invention. The illustrated network node system is for use in a wireless network as is apparent from the presence of an antenna ATN. However, the present invention may as well be employed in a wired network.

As mentioned above, the present invention may be employed in any kind and type of network. For example, the timestamp may be included in each and any kind of data packet, no matter if a unicast or a broadcast data packet. No special synchronization packets are required and consequently the overhead from the synchronization is very low. There is also no need for a special network topology. Thus, for example, the present invention is suitable for use in a wireless sensor network for medical applications.

A problem may still be a clock drift of different network node systems, but this is a common problem which effects all synchronization protocols. The clock drift depends on the tolerance and stability of a used crystal. A well known solution is clock drift compensation using linear regression or phase-locked loops (see e.g. Kay Römer, et al., “Time Synchronization and Calibration in Wireless Sensor Networks”, in: Ivan Stojmenovic (Ed.): Handbook of Sensor Networks: Algorithms and Architectures, John Wiley & Sons, ISBN 0-471-68472-4, pp. 199-237, September 2005). These methods may be used in the high precision time synchronization method according to the present invention.

Although detailed embodiments of the present invention are disclosed herein, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the mere fact that certain measures are recited in mutually different dependent claims does not indicate that a combination of these measures cannot be used to advantage.

Further, the terms and phrases used herein are not intended to be limiting; but rather, to provide an understandable description of the invention. The terms “a” or “an”, as used herein, are defined as one or more than one. The term another, as used herein, is defined as at least a second or more. The terms including and/or having, as used herein, are defined as comprising (i.e., open language). The term coupled, as used herein, is defined as connected, although not necessarily directly, and not necessarily by means of wires.

1. A method for time synchronization in a computer network, the computer network comprising at least a first network node system and a second network node system, the method comprising:
(a) generating a data packet in the first network node system for transmission to the second network node system, the data packet comprising a control block and a data block;
(b) providing the data packet to a transceiver of the first network node system;
(c) waiting a network access period by a network medium access control element;
(d) capturing a first node timestamp from the first network node system after step (c) and providing the first node timestamp to the transceiver for incorporating the first node timestamp in the data packet;
(e) transmitting the data packet by the transceiver.

2. A method according to claim 1, wherein at least a part of the control block has a predetermined position in the data packet with respect to a beginning of the data packet, and wherein the method further comprises:
(f) receiving the data packet by the second network node system;
(g) capturing a second node timestamp from the second network node system upon receiving the predetermined part of the control block;
(h) comparing the first node timestamp and the second node timestamp for determining a timer difference between the first node and the second node.

3. A method according to claim 2, wherein the method further comprises determining a transmission period between taking the first node timestamp and the transmission of the predetermined part of the control block; and wherein step (h) comprises taking into account the transmission period.

4. A method according to claim 3, wherein the predetermined part of the control block is a start-of-frame delimiter.

5. A method according to claim 1, wherein step (e) comprises:
(e1) performing by the network access control element a clear channel assessment for determining if a transmission channel is available;
(e2) if the channel is available, transmitting the data packet; and
(e3) if the channel is not available, repeating steps (d)-(e) after a delay, thereby updating the first node timestamp incorporated in the data packet.

6. A method according to claim 1, wherein the computer network is a wireless network.

7. A method according to claim 1, wherein the computer network is a sensor network.

8. A method for time synchronization in a computer network, the computer network comprising at least a first network node system and a second network node system, the method comprising:
(a) receiving by the second network node system a data packet transmitted by the first network node system in accordance with claim 1, the data packet comprising a first node timestamp;
(b) capturing a second node timestamp from the second network node system upon receiving at least a predetermined part of the data packet;
(c) comparing the first node timestamp and the second node timestamp for determining a timer difference between the first node system and the second node system.

9. A computer network node system comprising a microcontroller and a transceiver operatively coupled to the microcontroller, the microcontroller comprising a network medium access control element, the network node system being configured for performing the method according to claim 1.

10. A computer network node system comprising a microcontroller and a transceiver operatively coupled to the microcontroller, the microcontroller comprising a network medium access control element, the network node system being configured for performing the method according to claim 8.

11. A computer network node system according to claim 10, wherein the transceiver comprises a control signal output terminal for outputting a control signal upon receipt of a predetermined part of a control block, the control block output terminal being coupled to a timer capture input terminal of the microcontroller, the microcontroller being configured to capture a timer count as a second node timestamp upon receiving the control signal.
